(19) United States
(12) Patent Application Publication
(10) Pub. No.: US 2017/0352217 A1
(43) Pub. Date: Dec. 7, 2017

(54) MODULAR WIRELESS SYSTEM FOR UTILIZING ELECTRICAL INPUTS, OUTPUTS AND INPUT AND OUTPUT BASED FEEDBACK DURING LIVE PERFORMANCES

(71) Applicant: Lindsay Craig, Longmont, CO (US)

(72) Inventor: Lindsay Craig, Longmont, CO (US)

(21) Appl. No.: 15/170,920

(22) Filed: Jun. 1, 2016

(51) Int. Cl. G07C 13/00; G07C 11/00

(52) U.S. Cl. CPC G07C 13/00; G07C 11/00

(57) ABSTRACT

A network consisting of modules, each containing a wireless communication unit (106, 119, 135, 151), sensors (104, 105, 137, 138, 149) and/or actuators (103, 116, 118, 120, 134, 136, 150), allowing new dimensions of audience interaction. Each module is capable of input, output and signal filtering (102, 117, 133, 148). Behavior is controlled by a primary module (FIG. 1A) establishing module parameters including, but not limited to, output and sensor behavior, display data, non-primary module menu options, modules active in network and order of module communication. Modes of operation may allow non-primary modules (FIGS. 2A, 3A, 4A) to effect the primary module's settings creating a cyclical feedback in which the network's behavior (FIGS. 5A, 5B, 5C) is dependent on both primary and non-primary modules' output. The non-primary modules' portion of the network's output may be dependent upon a combination of non-primary module algorithms and sensor values. Inputs (104, 105, 137, 138, 149) and outputs (103, 116, 118, 120, 134, 136, 150) include, but are not limited to, audio components, LEDs, LED drivers, motors, relays, buttons, potentiometers, LCD displays, phones, piezo elements, accelerometers, gyroscopes, infrared emitters and detectors, temperature sensors and sonar sensors.

### CROSS-REFERENCE TO RELATED APPLICATIONS

N/A

### FEDERALLY SPONSORED RESEARCH

N/A

### SEQUENCE LISTING OR PROGRAM

Application contains four examples and flowcharts of computer programs that may be used as firmware with modules in the system. Application also contains six additional flowcharts outlining details of firmware operation. Application also contains a table explaining additional firmware behavior not outlined in the specified embodiment.

### Vocabulary Reference

Analog input Means of receiving an electrical signal with more values than the digital values of true or false, (on or off, no electricity present or electricity present) sources may include but are not limited to audio components, motors, potentiometers, rotary encoders, phones, piezo elements, accelerometers, gyroscopes, infrared detectors, temperature sensors, sonar sensors, 02 sensors, c02 sensors, LEDs, magnetometers, pressure sensors, flex sensors, lace sensors, hall effect sensors, light sensors, particulate sensors, air flow sensors, flow sensors, LIDAR, video, heart rate monitors, color sensors, computer imaging based sensors, active pixel sensors, reed switches, humidity sensors, EMI sensors, EMG sensors, SQUIDS or capacitance sensors.

Cyclical feedback A feedback loop whereby initial input to a sensor or module will change subsequent output signals or input options of said initial input signal as communication propagates throughout the network. Examples of cyclical feedback may include a change to a module which prompts a change in a second module, causing a change in the initial module's state and/or a change in how the network utilizes the initial module's input.

Digital input Means of receiving an electrical signal which is interpreted as either true or false. Most commons embodiments of digital inputs include buttons, relays, ICs, wireless communication based on boolean values. In some cases may also include analog inputs which have exceeded a preset threshold value.

Flow wand A cylindrical stick which is manipulated to create performance entertainment art. Manipulation is accomplished using two additional cylindrical sticks with two lengths of string strung between their two tips. The main cylindrical stick is suspended between the two strings, providing the illusion that the cylindrical stick is floating.

Hub A module that serves as a data collection and/or communication coordinator for multiple other modules.

Input and output parameters The values that define or allow a valid input or output.

Menu options Values displayed, or documented, which can be selected by means of an input in order to change an aspect and/or setting of a machine.

Non-primary user A secondary individual, most often an audience member, who uses an audience module.

Output component An electrical unit which creates an environmental or state change, types may include, but are not limited to, audio components, LEDs, LED drivers, motors, relays, servos, LCD displays, phones, piezo elements, infrared emitters, wireless communication units, sonar and electromagnetic units, may also be referred to as an actuator.

Performance art An art form that combines visual art and/or sound art with theatrical performance. This may also include athletic and educational performances.

Primary user An individual, most often a performer, who uses the trigger module.

Style One or more parameters that dictate the manner of activating an output component. These may include parameters and/or settings such as color, duration, intensity, position, pattern of activation, and rate of change.

Subnetwork Another network of interconnected units which communicates with the original network solely through a hub or hubs.

Threshold A value that specifies the border between the true and false transitions in a signal. May also refer to a value used to influence output component signals such that they are in one of two states, either operating at the level of said threshold or off.

Trigger A digital means of creating an electrical signal which is interpreted as either true or false, most commons embodiments include buttons, relays, ICs, wireless communication based boolean values, but may also include analog inputs which have exceeded a preset threshold value. Trigger may also may refer to the act of triggering.

Triggering The act of changing the electrical state of a trigger.

Wireless communication unit A means of sending values between the modules in the network. Possibilities include, but are not limited to, hardware capable of using IEEE 802.11, IEEE 802.15.4, IEE 802.16, 3GPP and 3GPP2 and WTP protocols.

### BACKGROUND

This system relates to embedded systems, particularly to usage in live performances, entertainment, polling and educational settings.

### Prior Art

The following is a tabulation of some prior art that presently appears relevant:

### U.S. Patent Applications

| | Kind | Publication | |
|---|---|---|---|
| Appl. Nr. | Code | Date | Patentee |
| 11/070,870 | A1 | Dec. 15, 2005 | George G. Mueller, Kevin J. |
| | | | Dowling, |
| | | | Ihor A. Lys |
| 14/484,460 | A1 | Apr. 16, 2015 | Gerard E. Reinhardt, |
| | | | Trevor Winckworth, Stephen |
| | | | Martin |
| 11/435,068 | A1 | Nov. 29, 2007 | Bao Tran |
| 11/875,916 | A1 | Jun. 26, 2008 | Peter Shorty, Tommas J. |
| | | | Christensen, Niels T. |
| | | | Johansen, Jacob Midtgaard, |
| | | | Johann Sigfredsson |
| 12/626,640 | A1 | Jun. 10, 2010 | Michael, V. Recker, David B. |
| | | | Levin |
| 11/004,449 | A1 | Jun. 16, 2005 | Lester F. Ludwig |
| 14/265,261 | A1 | Apr. 2, 2015 | David Plans, Davide Morelli, |
| | | | Dabriele Cocco, Nadeem Kassam |

### U.S. Patents

| | Kind | Publication | |
|---|---|---|---|
| Patent Nr. | Code | Date | Patentee |
| 6,719,433 | B1 | Apr. 13, 2004 | Richard S. Belliveau |
| 7,969,102 | B2 | Jun. 28, 2011 | Chris Chang |

### Foreign Patents

| | Kind | | |
|---|---|---|---|
| Patent Nr. | Code | Issue Date | Patentee |
| 2005084339 | A2 | Sep. 15, 2005 | George G. Mueller, |
| | | | Kevin J. Dowling, |
| | | | Ihor A. Lys |

Most modern performance art uses electronics to control lighting and additional media with control of lighting or additional media being controlled or maintained by a third party. Automated solutions exist in which aspects of a spotlight or a lighting system changes based on input from the environment or performance. However, in these solutions the input type is stalk; and remains constant throughout usage of the system. There are also feedback based performance systems that project an output, sound, video or light and simultaneously read input from sensors which in turn effect the output. These feedback performance systems add an extra dimension and responsiveness to the performance media, but they are limited in the media type they output, the type of feedback provided to the system, and they do not give the performer and the audience direct control over aspects of the feedback or media output. These feedback systems are also comprised of static inputs, although they provide responsiveness dependent on the system's output, the type of responsiveness is one dimensional because they cannot be altered by the performer during the performance.

Other systems outside of the music and entertainment industries exist, however these systems are also limited in the effect that an audience member's input has on the performance. Most are limited to simple answer and query media or non-primary user polling with an aggregation of answers displayed in the media, or at the end of the media. While this is an effective way to get information from audience members, it leaves something to be desired when applied to an artistic performance.

Network systems that allow for input which effects the output lighting or media are limited in that the audience member's interface input and operation cannot be controlled by the performer, other than to turn signal sources on or off. These systems are not designed so that the performer's input is effected by the audience member's input, only the final system output is effected by audience member or environment input. In much of the prior art cited the signal input from sources other than performers is also a fixed signal. This fixed signal's significance or source is never changed by the performer's input and remains the same through out all modes of usage.

Network based systems cited include patent application Ser. Nos. 11/070,870, 14/484,460, 11/435,068, 11/875,916, 14/265,261, U.S. Pat. No. 7,969,102 and International Patent 2005084339 (duplicate of patent application Ser. No. 11/070,870). The most extensive and pertinent of these, International Patent 2005084339, does not provide a means of altering the audience member interface or environmental input's source, function, menu options or thresholds. This means that all additional inputs, beyond the performer, are static systems. Thus, if an audience member's input or environmental sensor is used to measure an aspect of the audience and in turn control an unrelated aspect (For example, intensity or duration.) of the system's output. In these systems neither the audience member interface or environmental sensor input's function can be reconfigured by the performer's unit to sense different data or present different options to the audience member. For example, an environmental sensor in use by the audience or positioned in the audience which senses a certain frequency range of sound cannot be reconfigured to read in a separate frequency range of sound by the on stage performer during a performance. In the case that the audience member's interface provides a menu for value selection, this menu is static and the performer is not able to change the questions or values for which the audience member is providing input about during the performance. The network systems cited also do not tend to allow a performer to directly control the lighting systems, but necessitate a tertiary module or individual to process the signal or signals from the performer's output before the system finally activates outputs in the form of lighting. The other prior art citations, while pertinent through their network capabilities, are not addressed due to their lack of entertainment related inputs and outputs as well as the fact that none of these systems contain the input alteration and feedback advantages previously addressed.

Lighting based systems cited include patent application Ser. Nos. 11/070,870, 12/626,640, 11/004,449 and U.S. Pat. No. 7,969,102. U.S. Pat. Nos. 7,969,102, 6,719,433, patent application Ser. No. 11/070,870 and international patent 2005084339 (duplicate of Ser. No. 11/070,870) are network based lighting solutions, however they lack a depth of customization and multi-user control as discussed below. Only the most pertinent of these citations are addressed, the others, while related, lack key aspects such as a network or multiple input signals. U.S. Pat. No. 7,969,102 allows for its product to be responsive to sound and kinetic energy, however it does not allow a performer to control the activation of the lights. Nor does U.S. Pat. No. 7,969,102 allow incorporation of additional hardware or alteration of the system's overall action by the user. While a user of U.S. Pat. No. 7,969,102 may influence the lighting of the product through movement or sound in the environment, the parameters and signal sources are static. U.S. Pat. No. 6,719,433 is intended for closed loop usage, meaning that beyond the algorithm or system user and the feedback being provided by the cameras and projection system, there is no external feedback to change the operation of the system. U.S. Pat. No. 6,719,433 also does not incorporate any additional hardware as inputs or outputs. Shortcomings of patent application Ser. No. 11/070,870 have already been addressed in a previous paragraph.

All prior iterations of network based entertainment inputs, outputs and displays are limited in their abilities to perform a number of functions:
a. The networks are unable to reconfigure input sensor parameters.
b. The networks lack the ability to gather data from audience member participants in a dynamic, audience participant driven fashion.
c. None of the networks provide a feedback loop whereby the final output is effected by the performer input which is in turn effected the audience member input which was initially effected by the performer input, and so on, causing a cyclical feedback effect.
d. In most of the networks discussed the input and output units are kept separate, which does not allow for some more interesting and creative embedding and interaction possibilities.
e. In most of the networks discussed the output signal is, by necessity, piped through a single module or supportive personnel in order to filter, transpose or translate the originating output signal into the final output form.

### SUMMARY

In accordance with one embodiment an input and output network comprises a chain of modules, containing both electrical inputs and electrical outputs, which pass signals to each other in series allowing said modules to both effect the signals as well as triggering outputs, dependent on signal value.

### Advantages

Accordingly several advantages of one or more aspects are as follows: to provide configurable input and output parameters for each network in a real time updatable fashion, to allow performers control of supportive performance media in a manner which does not rely on additional filtering, translative software or hardware outside of the network loop, to allow audience members the ability to provide input and feedback which effects both the performer's output and the audience member's module's output, to allow for a cyclical form of feedback whereby each module's input has the capacity to change the entire system's output as well as its own input during subsequent communications, to allow polling of audience members in real time and to allow the incorporation of a multitude of creative inputs and outputs into a network which will have a direct effect on the performer's output. Other advantages of one or more aspects will be apparent from a consideration of the drawings and ensuing description.

### DRAWINGS

FIG. 1a is an electrical schematic of the trigger module.

FIG. 1b is an image of the enclosed trigger module.

FIG. 1c is an image of a cross section of the trigger module showing the internal components.

FIG. 1d is a flowchart of the computer code running on the trigger module.

FIG. 2a is an electrical schematic of the audio module.

FIG. 2b is an image of the enclosed audio module.

FIG. 2c is an image of a cross section of the audio module showing the internal components.

FIG. 2d is a flowchart of the computer code running on the audio module.

FIG. 3a is an electrical schematic of the additional input module.

FIG. 3b is an image of the enclosed additional input module.

FIG. 3c is an image of a cross section of the additional input module showing the internal components.

FIG. 3d is a flowchart of the computer code running on the additional input module.

FIG. 4a is an electrical schematic of the audience module.

FIG. 4b is an image of the enclosed audience module.

FIG. 4c is an image of a cross section of the audience module showing the internal components.

FIG. 4d is a flowchart of the computer code running on the audience module.

FIG. 4e is a flowchart detailing the portion of the computer code running on the audience module which is pertinent to a “mode” value of one which changes the behavior of the network so it effects output component activation and related variables.

FIG. 4f is a flowchart detailing the portion of the computer code running on the audience module which is pertinent to a “mode” value of two which changes the behavior of the network so it effects audio output.

FIG. 4g is a flowchart detailing the portion of the computer code running on the audience module which is pertinent to a “mode” value of three which changes the behavior of the network to allow audience rating feedback to be delivered to the trigger module.

FIG. 4h is a flowchart detailing the portion of the computer code running on the audience module which is pertinent to a “mode” value of four which effects the network so that the audience module documents information about the performer, venue, advertising and other pertinent information.

FIG. 5a is a flowchart showing how the modules in the system interact.

FIG. 5b is a flowchart showing an alternative network setup with an audience module subnetwork.

FIG. 5c is a table showing additional possible embodiments of the “mode” variable value based behaviors.

### REFERENCE NUMERALS

| | | | |
|---|---|---|---|
| 100 | battery or power source | 101 | switch or power switch |
| 102 | microprocessor or micro- | 103 | display |
| | controller | | |
| 104 | analog input or sensor | 105 | digital input, sensor or |
| | | | trigger |
| 106 | wireless communication | 110 | digital input, sensor or |
| | unit | | trigger |
| 115 | power source or power jack | 116 | audio control and storage |
| | | | unit |
| 117 | microprocessor or micro- | 118 | display |
| | controller | | |
| 119 | wireless communication unit | 120 | speaker jack or audio jack |
| 131 | battery or power source | 132 | switch or power switch |
| 133 | microprocessor or micro- | 134 | display |
| | controller | | |
| 135 | wireless communication unit | 136 | output component |
| 137 | analog input or sensor | 138 | digital input, sensor or |
| | | | trigger |
| 146 | battery or power source | 147 | switch or power switch |
| 148 | microprocessor or micro- | 149 | analog input or sensor |
| | controller | | |
| 150 | output component | 151 | wireless communication |
| | | | unit |

### DETAILED DESCRIPTION

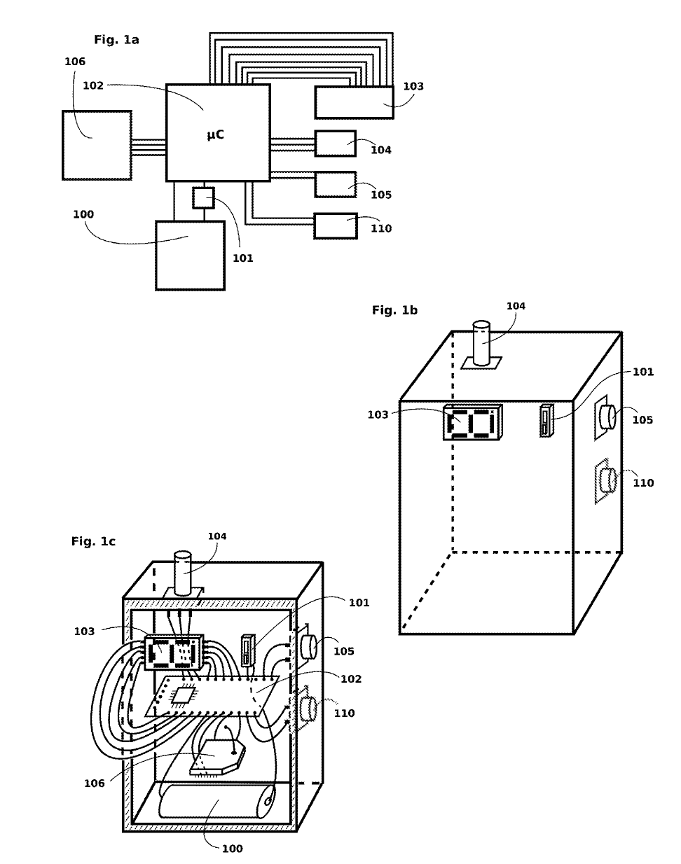

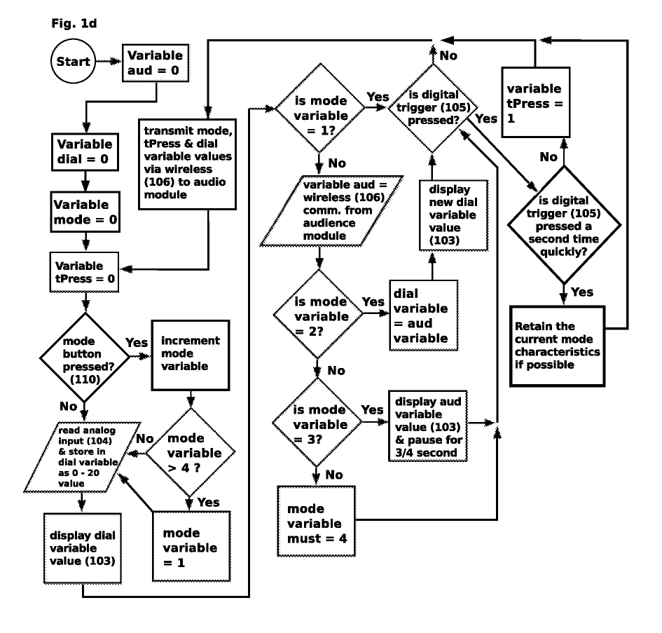

FIGS. 1a through 5c

### First Embodiment

A preferred embodiment of the present invention is illustrated in FIGS. 1a-5c. It is to be expressly understood that the descriptive embodiment is provided herein for explanatory purposes only and is not meant to unduly limit the claimed inventions. Other embodiments of the present invention are considered to be within the scope of the claimed inventions, including not only those embodiments that would be within the scope of one skilled in the art, but also as encompassed in technology developed in the future. A modular wireless system for activating electrical outputs and receiving inputs during performances is comprised of four types of modules described herein. Each of the modules communicate with each other and other wireless communication receivers and transmitters. Modules in the system each have a wireless unit for communicating and a form of either input, output or both for receiving information from a user or environment. Performers utilizing a trigger module are referred to hereafter as “primary users” and audience members are referred to hereafter as “non-primary users.”

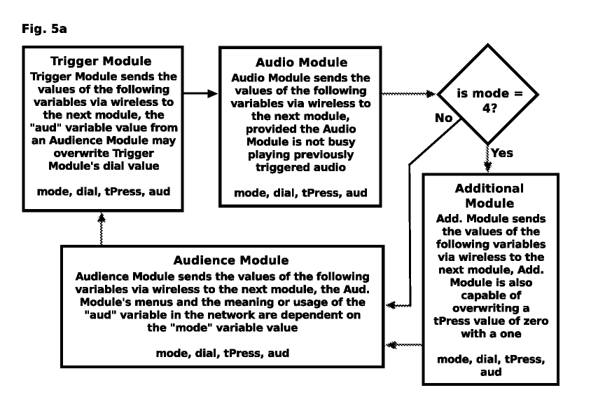

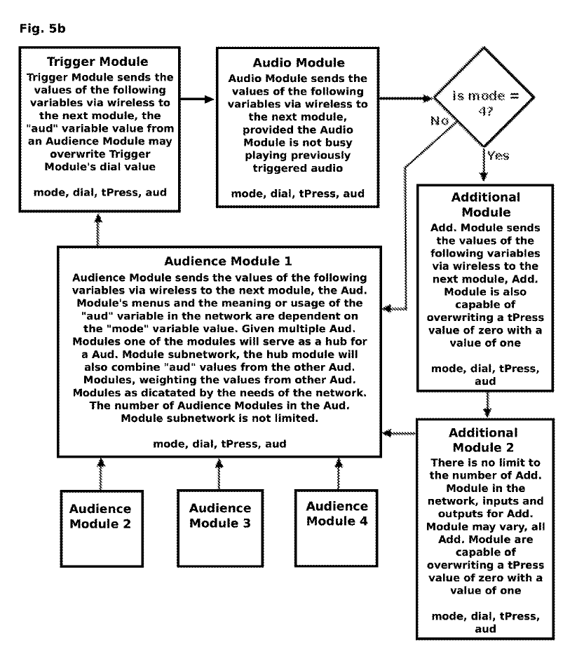

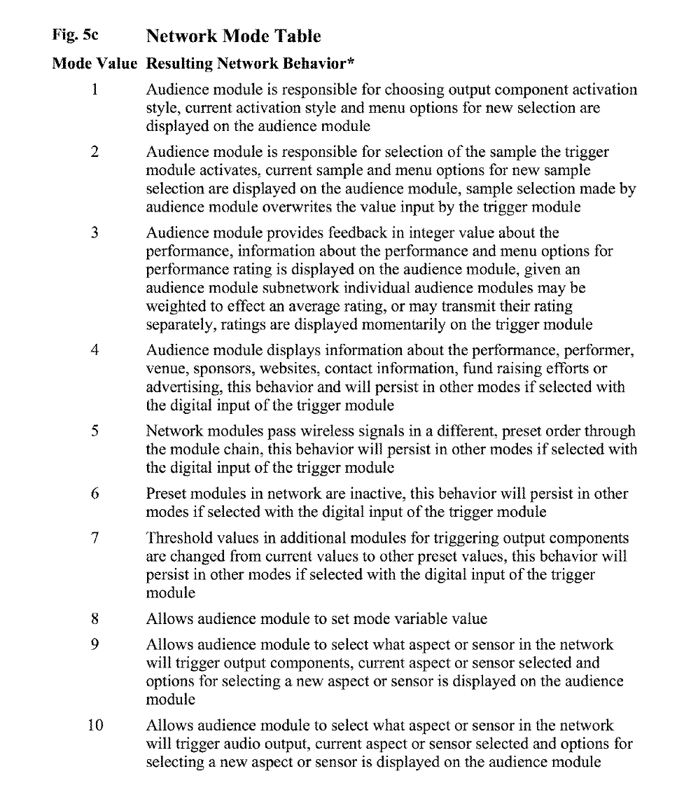

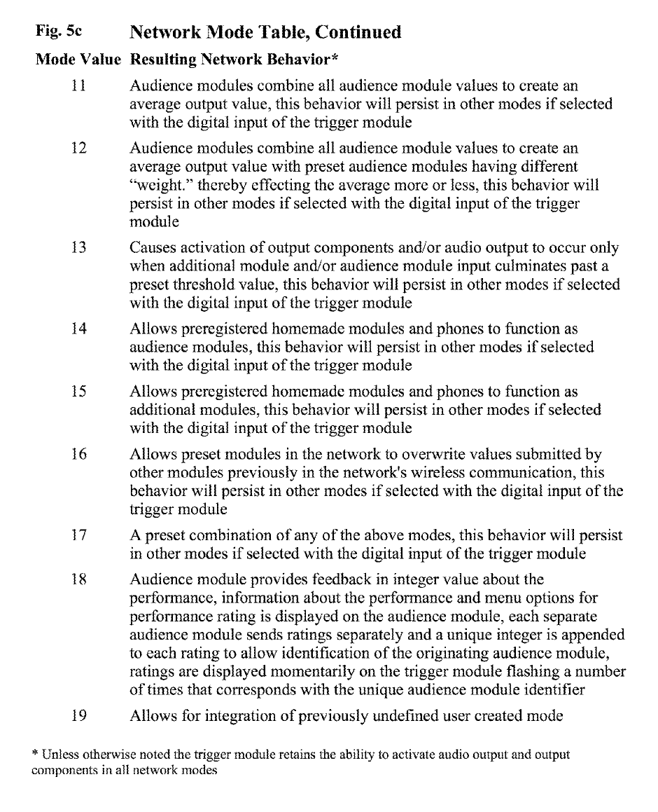

FIGS. 1a, 2a, 3a and 4a provide schematic diagrams showing elements of each type of module in the present invention. FIGS. 5A and 5b are flowcharts illustrating how these modules interacts with each other. Firmware resides in the microprocessors (μC) 102, 117, 133, 148 and is in electrical communication with the other components in the module. Modules communicate with each other through the use of wireless communication technology and a series of variables as indicated in the program flowcharts FIGS. 1d, 2d, 3d, 4d, 4e, 4f, 4g and 4h as well as module flowcharts 5a, 5b and 5c.

### Trigger Module—

FIG. 1b provides a perspective view of a trigger module and the components mounted on the trigger module's exterior. The trigger module has an analog input 104 on top of the module. The trigger module also has a display 103 which indicates current variable values and system states. There is a switch 101 which turns the power connection to the trigger module on or off. There are two additional digital inputs 105 and 110 which provide information for use in the firmware. The analog input 104, digital inputs 105 and 110 and display 103 are connected directly to a microprocessor 102 inside the trigger module. The power switch 101 is connected to both the microprocessor 102 and a power source 100 inside the trigger module.

FIG. 1c provides a cross section perspective view of the inside of the trigger module. In addition to the elements attached to the exterior of the trigger module, FIG. 1e contains the microprocessor 102, the power source 100 and a wireless communication unit 106. The power source's 100 ground line is connected directly to a ground pin on the microprocessor 102 and the power source's 100 power line is connected to the power switch 101. The power switch 101 is connected to the power input pin on the microprocessor 102, completing the powering circuit in the trigger module. The wireless communication unit 106 is connected directly to the microprocessor 102.

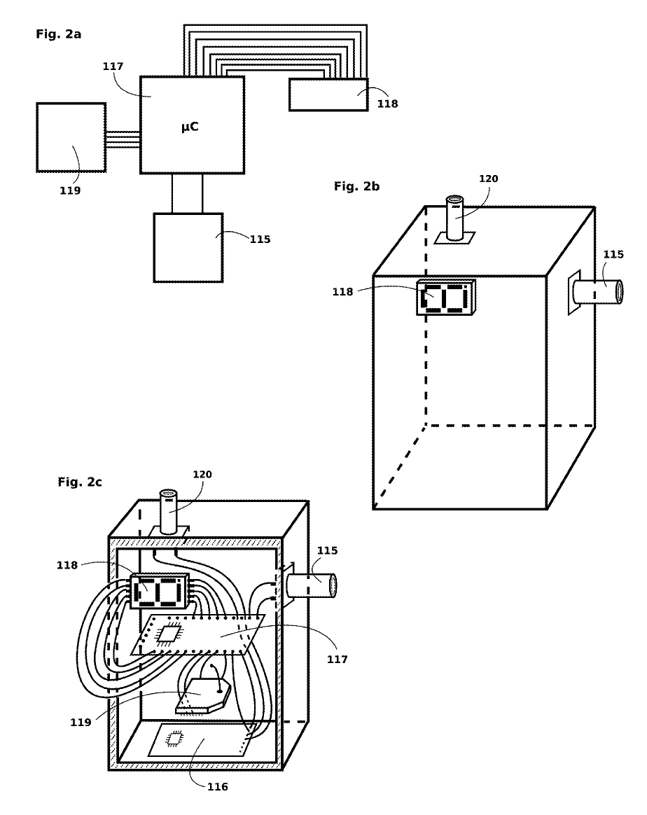

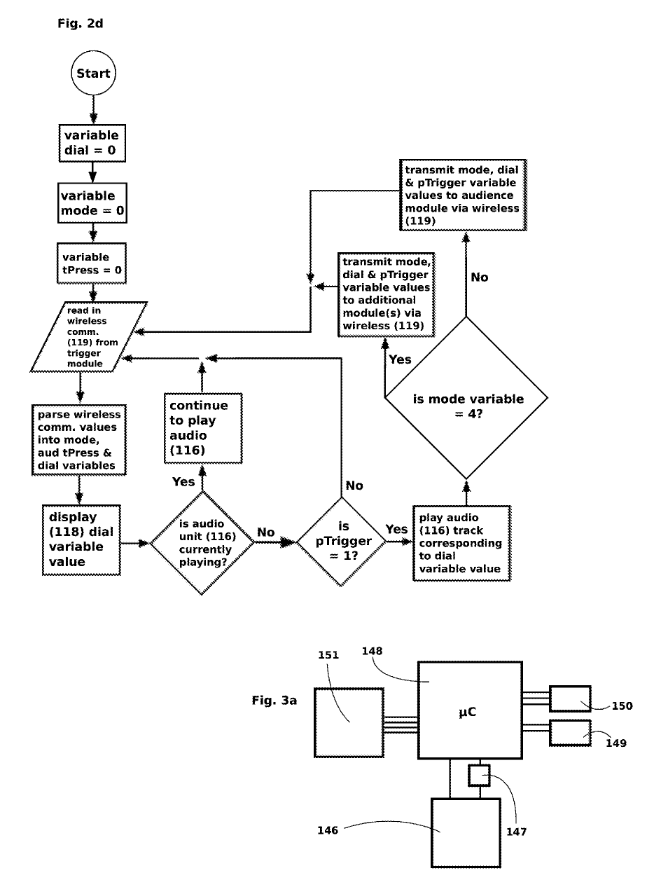

FIG. 1d shows the logic flow of this embodiment of firmware for the trigger module. In the trigger module the analog input 104 provides an electrical signal which is converted to a 0 through 20 integer value which is stored in the variable “dial” and written to the display 103, unless overridden by an “aud” variable from another module. One of the digital inputs 105 provides a value of one or zero which is stored in the “tPress” variable. The second digital input 110 increments a “mode” variable. The “mode” variable controls the type and style of outputs all other modules in the network will create as well as altering options for non-trigger modules feedback. Given a “mode” value of two or three the wireless communication module 106 reads in a value which is stored in the variable “aud.” In the case of a “mode” value of two the “aud” variable value is written to the “dial” variable. In the case of a “mode” value of three the “aud” variable is flashed on the display 103 for a short period of time. If the second digital input 110 is pushed twice in quick succession and the current mode allows it, the “mode” variable does not increment but the effects of the current mode are retained after the current mode is exited. Subsequent displays of “mode” values will flash the retained “mode” value before the current “mode” value. Pushing the second digital input 110 twice in quick succession while in a mode which has already been retained will remove retention of the mode. At the end of the firmware main loop the wireless communication unit 106 transmits a string of values which includes the values of the variables “dial,” “tPress” and “mode” to the next module in the network, the audio module FIG. 2a.

### Audio Module

FIG. 2b provides a perspective view of an audio module and the components mounted on the audio module's exterior. The audio module has a display 118 which indicates current variable values as passed to the audio module from the trigger module. There is a power jack 115 which connects the audio module to an exterior power source. There is an audio jack 120 which can be used to connect the audio out line of the audio module to a speaker, receiver or headphones. The power jack 115 and display 118 are connected directly to a microprocessor 117 inside the audio module.

FIG. 2c provides a cross section perspective view of the inside of the audio module. In addition to the elements attached to the exterior of the audio module, FIG. 2C contains the microprocessor 117, the audio control and storage unit 116 and a wireless communication unit 119. The wireless communication unit 119 and audio control and storage unit 116 are connected directly to the microprocessor 102. The audio jack 120 is connected to the audio control and storage unit 116.

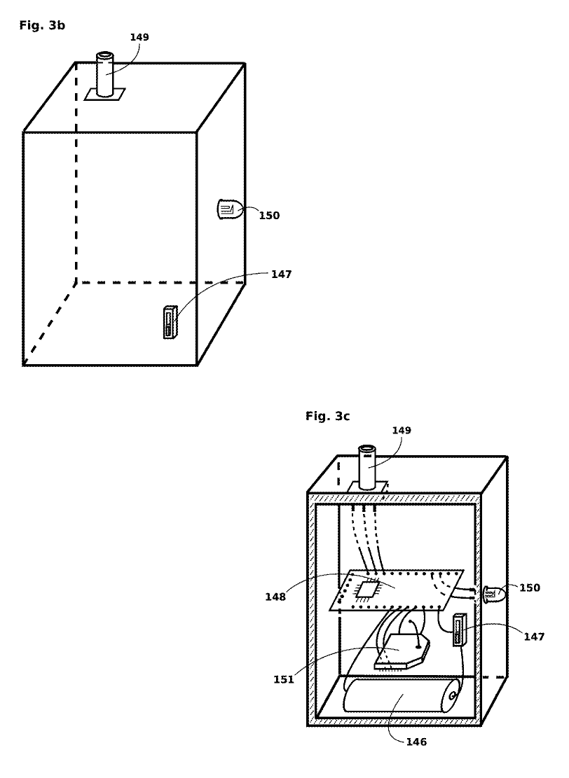

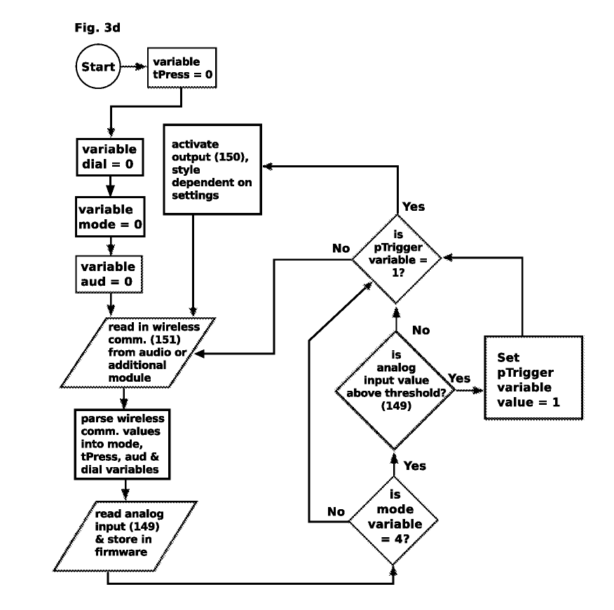

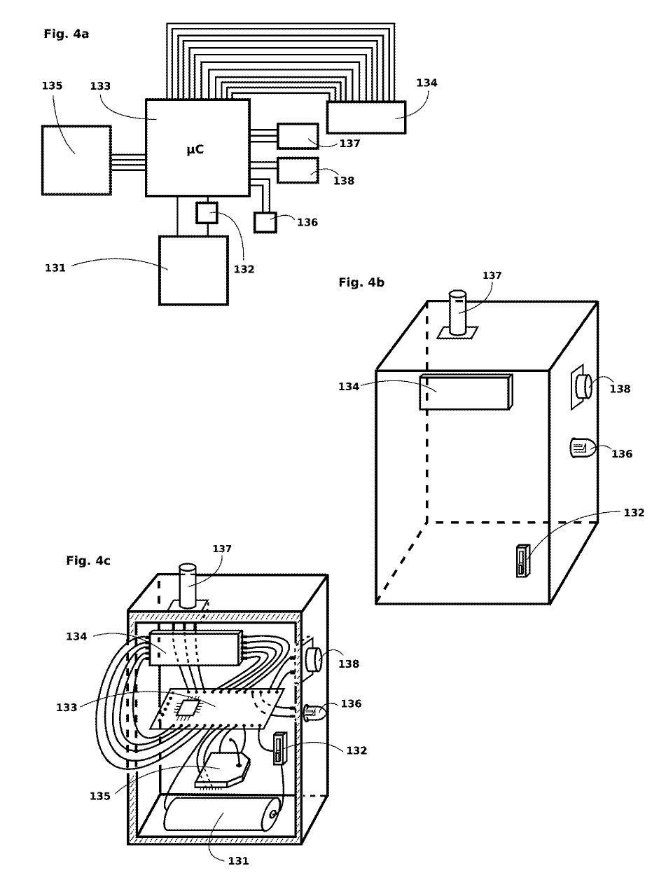

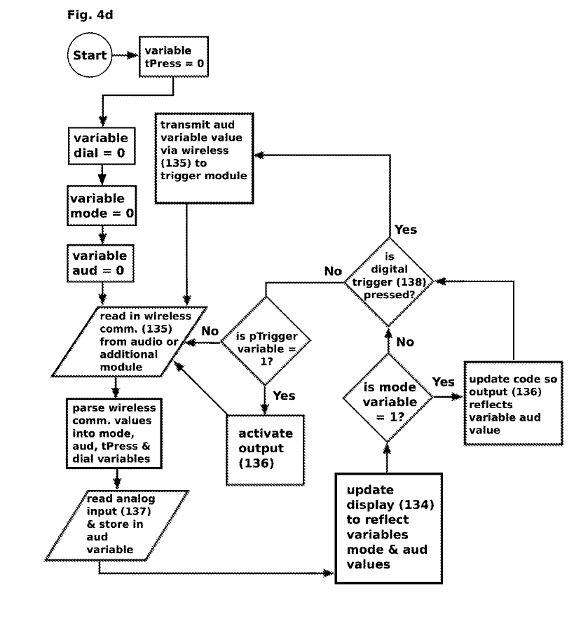

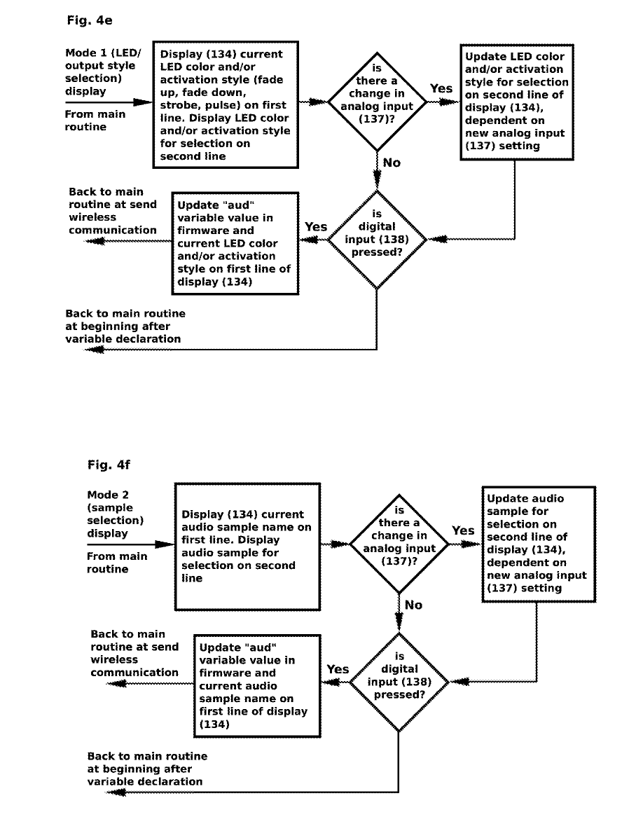

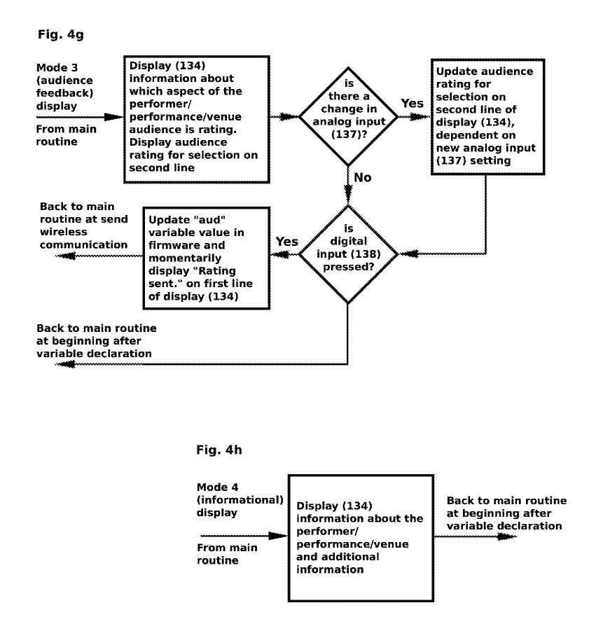

FIG. 2d shows the logic flow of this embodiment of firmware for the audio module. In the audio module the wireless communication unit 119 provides a string of values which are parsed and stored in the variables “dial,” “aud,” “mode,” and “tPress.” The “dial” variable is written to the display 118. When the “tPress” variable has a value of one the audio control and storage unit 116 plays an audio sample, provided it is not already in the process of playing audio. The actual audio sample the audio module plays is selected depending on a combination of the “mode” and “dial” variable. If the audio module was not already in the process of playing audio and a sample is triggered the audio module then relays the “dial,” “mode,” and “tPress” variable values to the next module in the network. If “mode” is set to a value of four the audio module will send a wireless communication to an additional module FIG. 3a. If “mode” is set to any other value the audio module will send a communication to an audience module FIG. 4a via wireless communication.

### Audience Module—

Assuming for the moment that the network's “mode” variable is not set to a value of four, the next module in the network chain is the audience unit illustrated in FIGS. 4a, 4b, 4c and 4d. FIG. 4b provides a perspective view of the audience module and the components mounted on the audience module's exterior. The audience module has an analog input 1 on top of the module. The audience module also has a display 134 which indicates current variable values, system states, information about a current performance and menu options. There is a digital input 138 on the side of the audience module which provides information for use in the firmware. Below the digital input 138 is an output component 136, in this embodiment an LED. There is a switch 132 which turns the power connection to the audience module on or off. The output component 136, analog input 137, digital input 138 and display 134 are connected directly to a microprocessor 133 inside the trigger module. The power switch 132 is connected to both the microprocessor 133 and a power source 131 inside the audience module.

FIG. 4c provides a cross section perspective view of the inside of the audience module. In addition to the elements attached to the exterior of the audience module, FIG. 4c contains the microprocessor 133, the power source 131 and a wireless communication unit 135. The power source's 131 ground line is connected directly to a ground pin on the microprocessor 133 and the power source's 131 power line is connected to the power switch 132. The power switch 132 is connected to the power input pin on the microprocessor 133, completing the powering circuit in the audience module. The wireless communication unit 135 is connected directly to the microprocessor 133.

FIG. 4d shows the logic flow of this embodiment of firmware for the audience module. In the audience module the wireless communication unit 135 provides a string of values which are parsed and stored in the variables “dial,” “aud,” “mode,” and “tPress.” Next the analog input sensor 137 reading is stored in the variable “aud” for later use. The display 134 shows various different menus options and information depending on the value of the “mode” variable.

Given a “mode” value of one the audience unit displays the current style of output and selects a new style of output which the network will use when activating output components. For example, in “mode” one the display may read “red strobe” as well as displaying a menu which allows the user to select the color of LED lighting, duration, intensity and strobe or pulse style. Output components in a network with this setting will strobe the color red, if possible, when activated.

Given a “mode” value of two the audience unit is used to display the current cued audio sample name and allows the user to select a new sample for curing, which is in turn activated by the trigger module.

Given a “mode” value of three the audience module displays different rating values that the audience can select and transmit to the trigger module to indicate their level of interest or perceived quality at the moment.

Given a “mode” value of four the audience module's inputs 137 and 138 have no effect and the display 134 shows information about the performer, performance and venue. The “aud” value, which is constantly updated, is used to navigate the menu options while the digital input 138 is used to select a menu option and send the selected values to the next module in the network via the wireless unit 135. Logic flow for the audience module's menus and display content are further outlined in FIGS. 4e, 4f, 4g and 4h. When the “tPress” variable has a value of one the output component 136 is activated. The functional action of the output depends on settings in firmware which are in turn dependent on the “mode” variable from the trigger module and the current settings in the audience module.

### Additional Module—

When the network's “mode” variable is set to a value of four, the next module in the network chain after the audio module is the additional module illustrated in FIGS. 3a, 3b, 3c and 3d. FIG. 3b provides a perspective view of the additional module and the components mounted on the additional module's exterior. The additional module has an analog input 149 on top of the module. On the side of the additional module is an output component 150, in this particular embodiment an LED or LED driver. There is a switch 147 which turns the power connection to the audience module on or off. The output component 150 and analog input 149 are connected directly to a microprocessor 148 inside the trigger module. The power switch 147 is connected to both the microprocessor 148 and a power source 146 inside the audience module.

FIG. 3c provides a cross section perspective view of the inside of the audience module. In addition to the elements attached to the exterior of the audience module, FIG. 3c contains the microprocessor 148, the power source 146 and a wireless communication unit 151. The power source's 146 ground line is connected directly to a ground pin on the microprocessor 148 and the power source's 146 power line is connected to the power switch 147. The power switch 147 is connected to the power input pin on the microprocessor 148, completing the powering circuit in the audience module. The wireless communication unit 151 is connected directly to the microprocessor 148.

FIG. 3d shows the logic flow of this embodiment of firmware for the additional module. In the additional module the wireless communication unit 151 provides a string of values which are parsed and stored in the variables “dial,” “aud,” “mode,” and “tPress.” The analog input 149 is read and the resulting value is stored in the firmware. Given a “mode” value of four the value from the analog sensor is compared with a preset threshold value. Mode four continues and if the threshold value is exceeded then the “tPress” variable value is set to one and the output component 150 is activated. Given a “mode” value of anything other than four the analog sensor value is ignored but the “tPress” variable value is still checked and a value of one activates the output component 150. At the end of the firmware main loop the wireless communication unit 151 transmits a string of values which includes the values of the variables “dial,” “tPress,” and “mode” to the next module in the network.

### Network Logic Flow—

FIG. 5a shows one possible embodiment of the setup for the network's wireless communication logic flow. A trigger module FIG. 1a sends a signal to an audio module FIG. 2a. Given a “mode” value of four the audio module FIG. 2a sends a signal to an additional module FIG. 3a, otherwise the signal is sent directly to an audience module. The additional module sends a signal to an audience module. FIG. 4a. The audience module completes the circular network by sending a signal back to the original trigger module FIG. 1a. The network is based on the idea that there can a plurality of each module, as well as the sequence and number of modules being modifiable.

FIG. 5b shows an alternative embodiment of network setup which operates almost the same as the network in FIG. 5a but with multiple audience modules. When multiple audience modules are present in the network the audience modules form a subnetwork with one of the modules serving as a hub to the primary network. “aud” variable values collected by the audience modules in the subnetwork can be added together, averaged or averaged with some audience modules values weighted more than others, resulting in a single value which is passed from the hub audience module to the rest of the network. Phones and audience created technology may serve as audience modules if they are preregistered before or during network usage.

FIG. 5c shows a table detailing possible embodiments for behavior of the network based on “mode” variable value.

Operation—FIGS. 1a through 5c

Modular network usage consists of two stages, setup and performance usage. During setup the number and types of modules in the network are established and the wireless communication units 106, 119, 135, 151 and module firmware are configured to establish order of signal communication throughout the network. With the exception of subnetworks, the signal is broadcast directly from one module to another. Network and output component 103, 116, 118, 134, 136, 150 behavior is dependent largely on the order of the communication between modules and “mode” setting. The network may be reconfigured in any manner to achieve the effect desired by the user.

One embodiment of in performance operation is broadly outlined in FIG. 5a. The following paragraphs outline one possible embodiment of network and module operation, but individual module firmware logic flow is largely dependent on “mode” variable value, see FIG. 5c.

The trigger module FIG. 1a checks an analog input sensor 104 and two digital input sensors 105, 110. The input value from the analog sensor is converted to a 1-20 integer value which is stored in the variable “dial” and displayed on a seven segment LED display 103. One of the digital sensor values 105, true or false (one or zero) is stored in the “tPress” variable. The other digital sensor 110, when pressed, increments the value of the variable “mode” by one. The “mode” variable controls the network behavior as outlined in FIG. 5c. On startup the “mode” variable has a value of zero, if the “mode” value exceeds nineteen it resets to a value of zero. When the “mode” value is changed the new value flashes briefly on the trigger module's seven segment display 103. The trigger module FIG. 1a checks the wireless communication unit 106 for incoming communication, which, given certain “mode” values may overwrite the current values of “mode” or “dial.” Incoming communication is parsed and pertinent values are stored in firmware. If incoming communication overwrites any variable values the trigger module's display 103 is updated to reflect this. If incoming communication indicates an audience rating value this value is displayed in a unique manner, allowing the primary user an understanding of the value's reference. For example, the “aud” value may flash four times on the display 103 to reflect the “fourth” audience unit in the network. Finally, the wireless communication unit 103 transmits the values of “mode,” “tPress,” “dial,” and “aud” along with a start byte, delimiters, an end byte and an optional checksum value to the next module in the network. Additional actions may result depending on certain “mode” values and are outlined in the last paragraph of this operation section as well as in FIG. 5c.

An audio module FIG. 2a checks its wireless communication unit 119 for incoming communication and parses pertinent values into the variables “mode,” “tPress,” “dial,” and “aud.” If a checksum value is present it is first checked to make sure the communication is valid. The audio module's display 118 is updated to reflect the current “dial” value. Given a value of one for the variable “tPress” and inactivity of the audio control and storage unit 116 an audio sample is activated and an audio signal exits the module via the audio jack 120. The audio sample activated corresponds to a combination of the “dial” value and the “mode” value, where the “mode” value is multiplied by twenty and added to the “dial” value. For example, a “dial” value of one and a “mode” value of zero would cause the activation of an audio sample numbered one, however a “dial” value of one and a “mode” value of two would cause the activation of an audio sample numbered forty one. In alternative embodiments an output signal may also be passed via a hardline to an attached computer or microprocessor based system given an audio sample activation. Finally, given an audio sample activation or a new “mode” value the wireless communication unit 119 transmits the values of “mode,” “tPress,” “dial,” and “aud” along with a start byte, delimiters, an end byte and an optional checksum value to the next module in the network.

An additional module FIG. 3a checks its wireless communication unit 151 for incoming communication and parses pertinent values into the variables “mode,” “tPress,” “dial,” and “aud.” If a checksum value is present it is first checked to make sure the communication is valid. Given a “tPress” value of one the additional module activates its output component 150 in the manner of style currently selected. For example, given an RGB LED output component 150 and a style value that corresponds to “red strobe” the module's RGB LED will strobe the color red. The additional module FIG. 3a then reads the analog input sensor's 149 value and stores the value in firmware. The additional module then checks the stored value against a threshold value. If the threshold value is exceeded by the analog input's 149 value the variable “tPress” is overwritten with a value of one and the output component 150 is activated. Given a “mode” value of seven, nine, ten or thirteen the threshold value and resulting behavior of outputs in additional modules FIG. 3a will vary. Finally, the wireless communication unit 151 transmits the values of “mode,” “tPress,” “dial,” and “aud” along with a start byte, delimiters, an end byte and an optional checksum value to the next module in the network. Additional actions may result depending on certain “mode” values and are outlined in the last paragraph of this operation section as well as in FIG. 5c.

An audience module FIG. 4a checks its wireless communication unit 135 for incoming communication and parses pertinent values into the variables “mode,” “tPress,” “dial,” and “aud.” If a checksum value is present it is first checked to make sure the communication is valid. Given a “tPress” value of one the audience module FIG. 4a activates its output component 136 in the manner of style currently selected. The audience module FIG. 4a reads the analog input sensor 137 and digital input sensor 138 and stores the values in firmware. The audience module's display 134 shows different text depending on “mode” value and the analog input's 137 sensor value. Examples of display menu logic are detailed in FIGS. 4e, 4f, 4g, 4h and 5c, these figures are examples only and audience display menu values are not limited to the examples outlined. The display 134 shows current menu selection values for the network as well as values or menu options which correspond to the current analog input 137 reading. The values or menu options which correspond to the current analog input 137 reading can be selected by pressing the digital input 138. Depending on “mode” the display 134 may also show additional information pertinent to the network or performance. Given an activated digital input 138 the audience module FIG. 4a stores the current analog input sensor 137 reading in the variable “aud” and transmits the values of “mode,” “tPress,” “dial,” and “aud” along with a start byte, delimiters, an end byte and an optional checksum value to the next module in the network via its wireless communication unit 135. Additional actions may result depending on certain “mode” values and are outlined in FIG. 5c. Explanations of “mode” related behavior contained in this specification do not reflect the full scope of possibilities for network and module behavior and should not limit the possible embodiments of network and module behaviors.

### CONCLUSION, RAMIFICATIONS, AND SCOPE

Thus, the reader will see that at least one embodiment of the modular wireless system for utilizing electrical inputs, outputs and input and output based feedback during live performances provides a more robust control of performance media for performers and a deeper opportunity for audience interaction. Embodiments of the network previously described also serve to provide the following advantages;
it provides configurable input and output parameters in a real time updatable fashion;
it allows primary users control of supportive performance media in a manner which does not rely on additional filtering or translative software or hardware outside of the network loop;
it allows performance attendees to provide input and feedback which effects both the performer's output as well as their own module's output; this non-hierarchical input behavior allows for a cyclical form of feedback whereby both the performer and the attendees module's input have the capacity to change the entire system's output, as well as the module's own input during subsequent communications;
it allows dynamic polling of performance attendees in real time which aids the performer in adjusting his or her performance to the tastes of each particular audience; and
it allows the incorporation of a plurality of creative inputs and outputs into a network which will have a direct effect on the primary user's output, thereby expanding the possibilities for audience interaction and media control.

While the above descriptions contains many specificities, these should not be construed as limitations on the scope, but rather as an exemplification of one, or several, embodiments thereof. Many other variations, embodiments and ramifications are possible. For example, other possible embodiments not pictured in the drawings or described previously are listed in the following paragraphs. The alternative embodiments listed may be incorporated with any of the modes of operation which depend on the “mode” variable previously discussed.

An alternative embodiment wherein a plurality of audience modules FIG. 4a are configured to create a subnetwork FIG. 5b comprised of audience modules. When used in this embodiment one of the audience modules serves as an aggregation hub which collects wireless data from the other audience modules in the subnetwork and performs calculations with the data before passing the data on to the rest of the network in the form of the “aud” variable. Calculations may include weighting a particular audience unit's data so that it effects the end result variable more or less. In this embodiment an audience module may also be connected to a website, whereby a value passed from the website serves in place of the standard audience module's analog sensor or input.

Another alternative embodiment wherein a plurality of additional modules FIG. 3a are configured to create a subnetwork similar to the subnetwork FIG. 5b comprised of audience modules. When used in this embodiment one of the additional modules serves as an aggregation hub which collects wireless data from the other additional modules in the subnetwork and performs calculations with the data before passing the data on to the rest of the network in the form of the “tPress” variable. Calculations may include weighting a particular additional unit's data so that it overrides the end result of the subnetwork more or less. In this embodiment an additional module may also be connected to a website, whereby a value passed from the website serves in place of the standard additional module's analog sensor or input.

Another alternative embodiment wherein additional modules pass a new integer type variable, “addit,” as opposed to the variable “tPress,” which is equal to the reading of the analog sensor or input of the additional module. In the case that there is said subnetwork or additional modules the firmware allows for the subnetwork to perform in a manner which creates the variable value in a plurality of manners. One possible manner is for the highest value in the subnetwork to be written to the variable. One possible manner is for the lowest value in the subnetwork to be written to the variable. One possible manner is for the subnetwork to add together all the collected values as one larger value to be passed on in communication. One possible manner is for certain additional modules to be weighted more or less than other additional modules with the subnetwork creating an average variable value.

Another alternative embodiment allows for phones to be used as additional modules.

Another alternative embodiment allows for phones to be used as audience modules.

Alternative embodiments specifically for additional modules include the following sensors and embodiments:
A beach ball or inflatable object with a piezo sensor to allow impact measurement to create the “tPress” or “addit” variable value.
A slide, or horizontal surface with a force pressure sensor to allow impact measurement to create the “tPress” or “addit” variable value.
A slide, or horizontal surface with a plurality of force pressure sensors to allow length of movement along said slide or velocity of movement on said slide to create the “tPress” or “addit” variable value.
A sonar sensor to allow for height of individuals in the audience or on stage to create the “tPress” or “addit” variable value.
A LIDAR sensor to allow for height of individuals in the audience or on stage to create the “tPress” or “addit” variable value.
An infrared emitter and detector sensor to allow for height of crowd to create the “tPress” or “addit” variable value.
An accelerometer embedded in clothing or a helmet to allow dancers to create the “tPress” or “addit” variable value.
An accelerometer embedded in a “flow wand” to allow “flow wand” users to create the “tPress” or “addit” variable value.
A microphone to allow the decibel level of a crowd to create the “tPress” or “addit” variable value.
Additional module with the input sensor disabled so that the module serves only as an output.
Additional module with the output sensor disabled so that the module serves only as an input.

Accordingly the scope should be determined not by the embodiments illustrated but by the appended claims and their legal equivalents.

I claim:

1. A collection of machines for activating outputs, collecting input data, applying algorithms to said input data, transmitting information between machines and real time alteration of said algorithms, comprising:
a. at least one electrical system comprised of:
i. an analog sensor
ii. a digital sensor,
iii. a microprocessor with digital memory,
iv. a wireless communication unit,
v. an electrical output component,
vi. electrical connections between said microprocessor and each of said sensors, units and components,
vii. said microprocessor as a means of storing values from said analog and digital sensors in said memory,
viii. said electrical output component as a means of documenting variable values from said memory such that a user can observe said variables,
ix. said wireless communication unit as a means of transmitting communication wirelessly from said device to another device,
x. said wireless communication unit as a means of receiving communication wirelessly from another device,
xi. said microprocessor as a means of storing values from said communication in said memory, and
xii. said microprocessor as a means of hosting firmware to achieve the aforementioned capabilities,
b. at least one electrical system comprised of:
i. a microprocessor with digital memory,
ii. an audio unit capable of storing and playing an audio signal,
iii. a wireless communication unit,
iv. an electrical output component,
v. electrical connections between said microprocessor and each of said units and components,
vi. said wireless communication unit as a means of receiving communication wirelessly from another device,
vii. said microprocessor as a means of storing values from said communication in said memory,
viii. said wireless communication unit as a means of transmitting communication wirelessly from said device to another device,
ix. said audio unit as a means of outputting said audio signal dependent on said values in said memory,
x. said electrical output component as a means of documenting variable values from said memory such that the user can observe said variables, and
xi. said microprocessor as a means of hosting firmware to achieve the aforementioned capabilities,
c. at least one electrical system comprised of:
i. a microprocessor with digital memory,
ii. an analog sensor
iii. a digital sensor,
iv. an electrical output,
v. electrical connections between said microprocessor and each of said sensors and components,
vi. said wireless communication unit as a means of receiving communication wirelessly from another device,
vii. said microprocessor as a means of storing values from said communication in said memory,
viii. said wireless communication unit as a means of transmitting communication wirelessly from said device to another device,
ix. said microprocessor as a means of storing values from said analog and digital sensors in said memory,
x. said microprocessor as a means of activating said electrical outputs dependent on said values in said memory, and
xi. said microprocessor as a means of hosting firmware to achieve the aforementioned capabilities,
whereby each of said devices' communication settings, communication content, said sensors' behavior, said electrical output behavior, said audio output, and said documentation's content are capable of being altered and activated by any of other said devices in said collection.

2. The collection of machines of claim 1 wherein said machines contain a plurality of digital sensors.

3. The collection of machines of claim 1 wherein said machines contain a plurality of electrical outputs.

4. The collection of machines of claim 2 wherein said machines contain a plurality of electrical outputs.

5. The collection of machines of claim 1 wherein each of said devices is capable of transmitting and receiving said wireless communication with a plurality of said devices at the same time.

6. Multiple methods of activating outputs, collecting input data, applying algorithms to said input data, transmitting information between multiple machines and real time alteration of said algorithms, comprising:
a. providing a means of reading analog and digital sensors,
b. providing a means of storing values from said analog and digital sensors in memory,
c. providing a means of documenting variable values from said memory such that the user can observe said documentation,
d. providing a means of transmitting communication wirelessly to another device,
e. providing a means of outputting an audio signal dependent on said values in said memory,
f. providing a means of receiving communication wirelessly from another device,
g. providing a means of storing values from said communication in memory,
h. providing a means of outputting an audio signal dependent on said values in said memory,
i. providing a means of activating electrical outputs dependent on said values in said memory, and
j. providing a means of hosting firmware to achieve the aforementioned capabilities,
whereby multiple unique methods comprised of different combinations of the aforementioned methods can alter another method's communication settings, communication content, methods effecting said sensors', methods effecting said electrical output, said audio output, and said documentation's content.

7. The collection of machines of claim 1 wherein some of the machines communicate via a hardline instead of wireless communication.

8. The methods of claim 6 wherein some of the communication occurs via a hardline instead of wireless communication.

9. The collection of machines of claim 1 wherein said memory and said firmware is located in a different physical location from all other said components and said sensor reading values and said output component activation signals are sent and received via wireless communication.
